(19) United States
(12) Patent Application Publication
(10) Pub. No.: US 2008/0008345 A1
(43) Pub. Date: Jan. 10, 2008

(54) Method and apparatus for sound engineered metal channel supports and panel products

(75) Inventor: Bruce Donaldson, San Anselmo, CA (US)

Correspondence Address: REED SMITH, LLP, TWO EMBARCADERO CENTER, SUITE 2000, SAN FRANCISCO, CA, 94111, US

(73) Assignee: Supress Products, LLC, San Anselmo, CA (US)

(21) Appl. No.: 11/825,436

(22) Filed: Jul. 6, 2007

Related U.S. Application Data
(60) Provisional application No. 60/806,703, filed on Jul. 6, 2006.

(51) Int. Cl. H04R 1/02

(52) U.S. Cl. 381/386

(57) ABSTRACT

A metal channel includes at least one contact surface with a sound/vibration suppression material disposed on the contact surface. The contact surface attaches to a panel product such as drywall used in walls and ceilings. In one embodiment, the suppression layer is a lamination of glue, polymer, and scratch resistant layers. The contact surface may also attach or otherwise contact a contact surface of another metal channel and/or a complimentary metal channel that when fitted together comprise at least part of a building structure. The panel attached to any of the channels is, for example, a drywall product such as SUPRESS™ brand sound engineered products.

### CROSS-REFERENCE

This application claims the benefit of the filing date of U.S. Provisional Application Ser. No.: 60/806,703, filed Jul. 6, 2006, entitled “Method and Apparatus for Sound engineered Metal Channel Supports and Panel Products,” the entire disclosures of which are hereby incorporated by reference into the present disclosure.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of Invention

The present invention relates to sound engineered building materials. The invention is more particularly related to channels and other support members engineered to reduce sound and vibration transmissions.

2. Discussion of Background

Various types of studs are used in the construction of buildings and typically provide support for walls, ceilings, and floors. Such supports include 2×4 framing, ceiling, and floor joists. Metal studs are also widely used in building construction, for example in the construction of non-load-bearing interior walls and ceilings. The studs generally are used as foundation and support for drywall products which are attached to the studs to form interior walls of the structure in which they are used.

Metal channels of various types are also known. Like studs, metal channels provide points for attachment and support of drywall or other panel materials. Metal channels are typically used in ceiling panel support.

### SUMMARY OF THE INVENTION

In one embodiment, the present invention comprises a support structure comprising a main support member and at least one vibration/sound suppression layer attached to the main support member.

In another embodiment, the main support structure is a metal channel having a contact area configured to contact a building product. The contacted building product is for example, another channel, drywall, and/or sound engineered drywall. The contact area includes the vibration/sound suppression layer.

In one embodiment the vibration/sound suppression material comprises a polymer layer, an adhesive layer, and an abrasion resistance layer. The metal channel may comprise a top area and at least one brim area.

The present invention includes a method of construction, comprising the steps of attaching a vibration/sound suppression material to a channel member; installing the channel member for support of a panel product; attaching the panel product to the channel member, wherein the vibration/sound suppression material on the channel member contacts the panel product. In one embodiment, the panel product is a sound engineered drywall product. In yet another embodiment, the panel product is a ceiling material. The invention is practiced, for example, in the construction of entertainment rooms, including, for example, reading rooms, study rooms, practice rooms, classrooms, television rooms, sound rooms, studios, and movie theaters.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a drawing of a type of sound engineered drywall product;

FIG. 2 is a drawing of a metal channel product 200 according to an embodiment of the present invention;

FIG. 3 is a perspective view of the metal channel product in FIG. 2 according to an embodiment of the present invention;

FIG. 4 is a drawing of AN RC-1 metal channel product 400 according to an embodiment of the present invention;

FIG. 5 is a perspective view of the RC-1 metal channel product 400 according to an embodiment of the present invention;

FIG. 6 is a flow chart describing processes for installing metal channel products without pre-installed sound suppression strips according to embodiments of the present invention.

FIG. 7 is a flow chart describing a process of installing a metal channel product and attaching a panel product according to embodiments of the present invention;

FIG. 8 is a drawing of an installed metal channel product for ceilings according to an embodiment of the present invention; and

FIG. 9 is a drawing of an installed metal channel product for walls according to an embodiment of the present invention.

### DESCRIPTION OF THE PREFERRED EMBODIMENTS

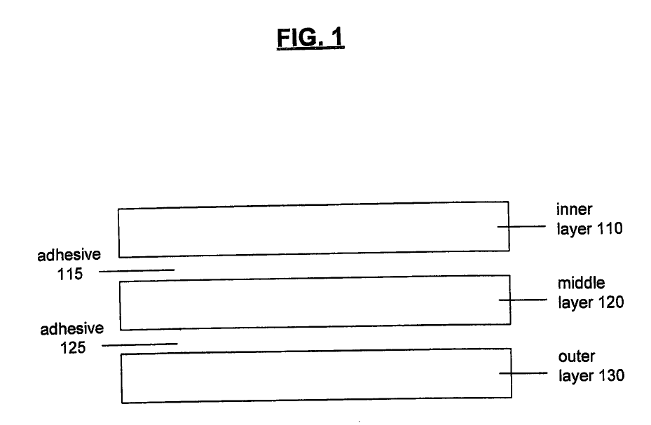

Referring now to the drawings, wherein like reference numerals designate identical or corresponding parts, and more particularly to FIG. 1 thereof, there is illustrated in FIG. 1 a drawing of a sound engineered drywall product 100. The sound engineered drywall product 100 is a panel product comprising a series of layers composed of, for example, any of gypsum board, wood, man-made materials, compressed products, or other materials. The layers include, for example, an inner layer 110 and an outer layer 130. The illustrated example also includes a single middle layer 120. Additional same sized or different sized layers may also be utilized. Adhesive is disposed between the layers (e.g., adhesive 115 and 125). The adhesive is, for example, an acoustical adhesive such as Supress™ Acoustical Sealant, or commercially available visco-elastic adhesives.

The sound engineered drywall is, for example, of the type commercially available from Supress™ Products LLC of San Rafael Calif. These products represent high-performance sound and vibration absorbing panels for commercial and residential construction. The Supress™ products also have the advantage of being available in a ½″ thick panel and thereby require no re-design for existing plans using standard ½″ drywall. Higher performance panels include more layers, such as up to STC 75+ in Supress™ products available in ⅝″ or ¾″ home theater or 1″ professional sound studio versions that may also be used to provide sound absorption in children's rooms, play areas or anywhere desired to be insulated from sound or vibrations. The insulating qualities of such products are magnified by the use of supports that also reduce sound transmission (e.g., sound engineered metal channel products as described herein).

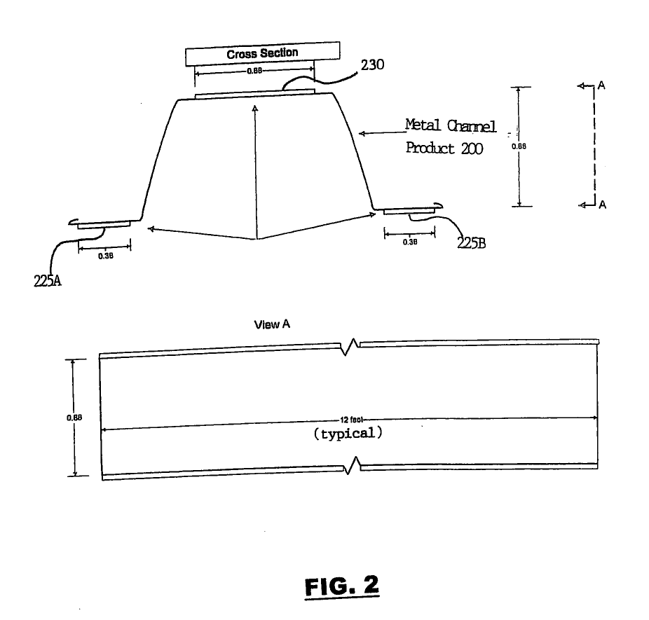

FIG. 2 is a drawing of a metal channel product 200 according to an embodiment of the present invention. The metal channel product 200 is a hat channel type support. The illustrated exemplary hat channel includes a top area and two side brims, the top area having sound suppression material 230, and each side brim having sound suppression material 225 attached (225A and 225B). The location of sound suppression materials is preferably at contact areas of the metal product (e.g., the contact areas include, for example, areas that contact other metal products, areas that are secured to foundations, other supports, and areas that contact panel products).

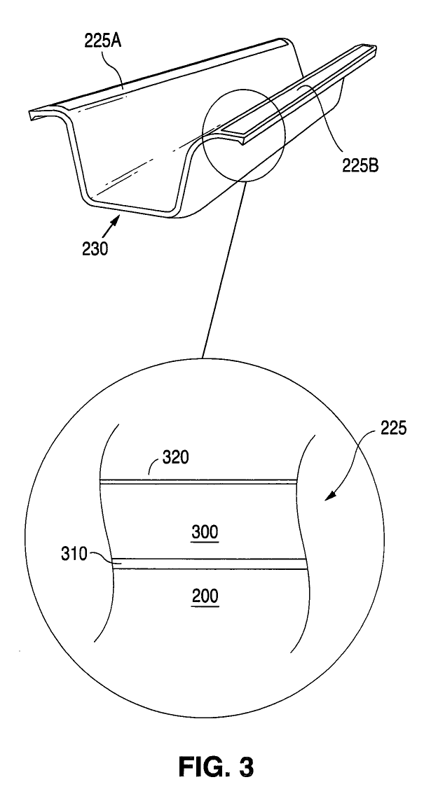

FIG. 3 is a perspective view of the metal channel product 200 in according to an embodiment of the present invention. As shown in FIG. 3, the sound suppression materials preferably comprise a strip that runs lengthwise along the contact areas. The sound suppression material 225 is illustrated as being constructed of layers, namely a polymer layer 300 for the absorption of sounds/vibrations, an adhesive layer 310 to attach the polymer layer 300 to the metal channel 200, and an abrasion resistance layer 320 (e.g., hard plastic layer such as [Ponolic] hard plastic) that also helps absorb sound and functions as abrasion resistance used to protect the polymer layer 300 from being damaged or removed by contact with other materials, particularly at the construction site or during shipping. The sound suppression material 230 is similarly constructed to material 225, but is, for example, wider (to better fit the wider top area of the hat channel).

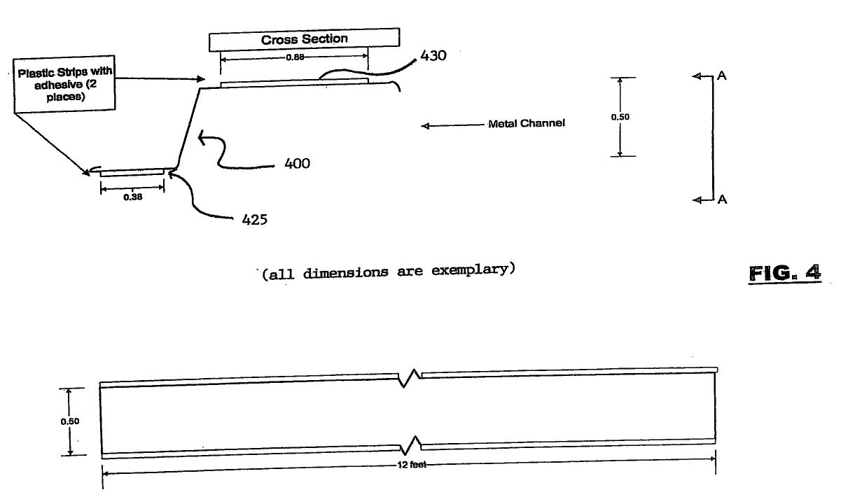

FIG. 4 is a drawing of an RC-1 metal channel product 400 according to an embodiment of the present invention. The RC-1 metal channel product 400 is an RC-1 channel type support. The illustrated exemplary RC-1 channel type support includes a top area and one side brim, the top area having sound suppression material 430 attached, and the side brim having sound suppression material 425 attached. The location of sound suppression materials is preferably at contact areas of the metal product (e.g., the contact areas include, for example, areas that contact other metal products, areas that are secured to foundations or other supports, and areas that contact panel products).

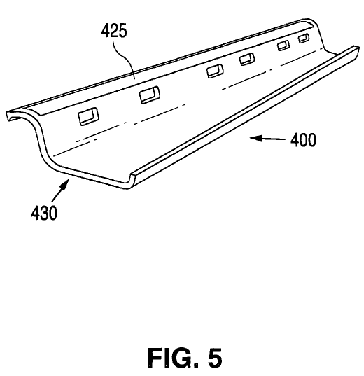

FIG. 5 is a perspective view of the RC-1 metal channel product shown in FIG. 5 according to an embodiment of the present invention. As shown in FIG. 5, the sound suppression materials preferably comprise a strip that runs lengthwise along the contact areas of the metal product 400. The sound suppression materials 425 and 430 are, for example, constructed similarly to the sound suppression materials described above with reference to FIG. 3. The sound suppression materials may alternately be constructed from materials such as foam or other flexible substances.

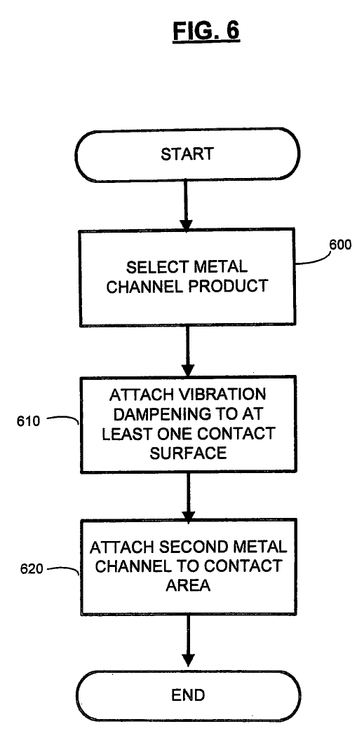

FIG. 6 is a flow chart describing a process of installing a metal channel product and attaching a panel product according to an embodiment of the present invention. This process takes advantage of the present invention but utilizes entirely standard metal channel products. At step 600, a standard metal channel product is selected. At step 610, a vibration damping strip is attached to the selected metal channel product (e.g., sound suppression materials similar to any of 225, 230, 425, or 430). The metal channel product may be installed on its support prior to attachment of the sound suppression material, but, preferably, the sound suppression material includes a sound suppression strip where the metal channel product contacts its support. Therefore, in most cases, it will be more efficient to install all of the sound suppression strips prior to installing the metal channel product to its support.

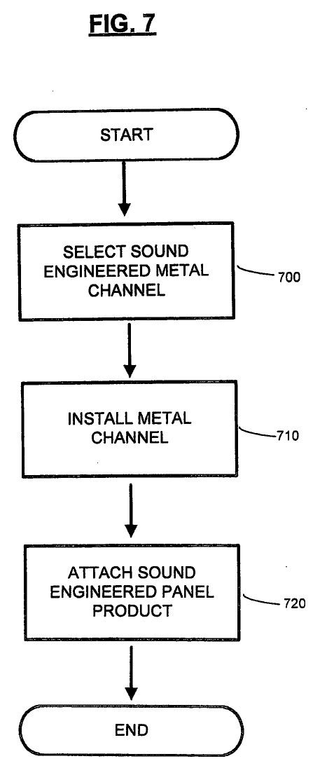

FIG. 7 is a flow chart describing a process of installing a metal channel product and attaching a panel product according to an embodiment of the present invention. At step 700 a sound engineered metal channel product having one or more sound/vibration damping strips (e.g., sound suppression material) is selected. The selected metal channel product is installed to a support (step 710). And, at step 720, a panel product is attached to the installed metal channel product. Preferably, the panel product is a sound engineered panel for one of walls, ceilings, and/or floors (for example, any of Supress™ sound engineered drywall products discussed above). The use of the Supress™ products amplifies the sound suppression properties of both the drywall product and the metal channel product; the combination providing additional sound suppression in any project using both the channels and drywall.

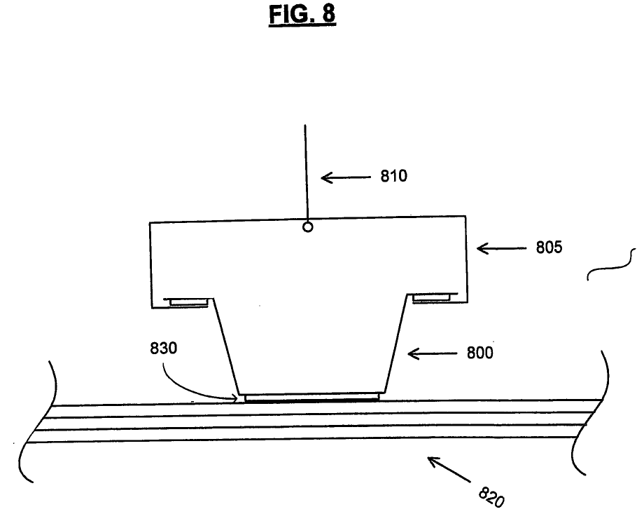

FIG. 8 is a drawing of an installed metal channel product 800 for ceilings according to an embodiment of the present invention. The illustrated metal channel product 800 is similar to the hat channel product 200 described above, except that the brim sound suppression materials are adhered to the opposite sides of the brims. The hat brim contact areas attach/fit in to a ceiling support 805 hung from a roof or upper floor of a building (e.g., support wires 810). Note that in an alternate embodiment, the sound suppression materials may be installed on contact areas of the ceiling support 805 instead of metal channel product 800. The top portion of the metal channel product 800 (hat channel) is attached to a ceiling panel 820 (e.g., Supress™ sound engineered drywall, or another panel product). Sound suppression material 830 is shown disposed between the hat channel product 200 and the ceiling panel 820. The ceiling panel product is secured to the metal channel product 800 via, for example, drywall screws (not shown).

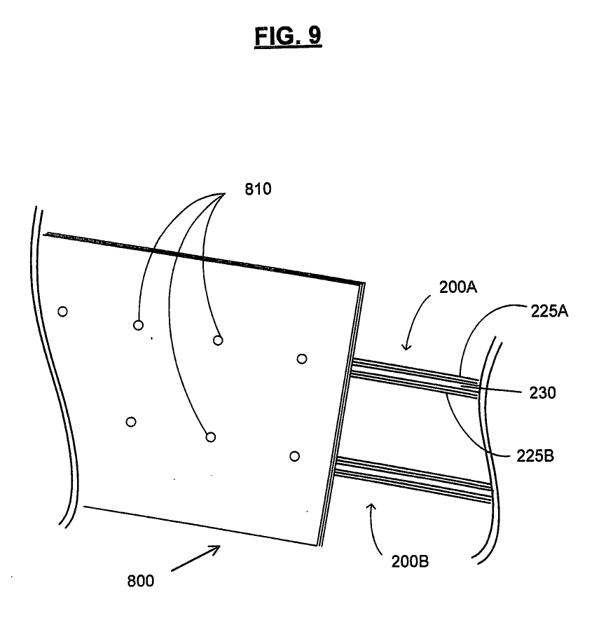

FIG. 9 is a drawing of an installed metal channel product for walls according to an embodiment of the present invention. A pair of hat channel products 200A, and 200B are attached to a support (e.g., wood or metal studs, not shown). Alternatively a single or triplet of hat channel products may be utilized. A panel product (e.g., Supress™ sound engineered drywall) is attached to the top area of the hat channel products via adhesive or, for example, sheetrock metal screws 810.

Other examples of the present invention will be readily apparent to the skilled practitioner upon review of the present disclosure. The same principles of applying a sound/vibration in damping strip may be utilized between any support and other supports or panel products and the invention is therefore not limited to hat channel or RC-1 type metal products but extends to all available framing and support members for any type of ceiling, wall, or floor panels and materials.

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. For example, when describing metal channel product, any other equivalent device, such as a metal stud, frame, or joist, or other device having an equivalent function or capability, whether or not listed herein, may be substituted therewith. Furthermore, the inventor recognizes that newly developed technologies not now known may also be substituted for the described parts and still not depart from the scope of the present invention. All other described items, including, but not limited to adhesives, sound absorption materials (including foams, polymers, and plastics, etc), building materials (including channels, other metal products, studs, joists, panel products of different materials) should also be considered in light of any and all available equivalents.

The present invention may suitably comprise, consist of, or consist essentially of, any of element (the various parts or features of the invention, e.g., support products including metal channels having contact areas, sound suppression materials, sound engineered panel or drywall products, acoustical adhesives) and their equivalents as described herein. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of claims to be appended in a subsequently filed utility patent application, the invention may be practiced otherwise than as specifically described herein.

What is claimed is:

1. A support structure comprising:
a main support member; and
vibration/sound suppression material attached to the main support member.

2. The support structure of claim 1, wherein the vibration/sound suppression material comprises a polymer layer, an adhesive layer, and an abrasion resistance layer.

3. The support structure of claim 1, wherein the main support member is a metal channel having a contact area configured to contact a building product, wherein the vibration/sound suppression material is attached to the contact area of the metal channel.

4. The support structure of claim 3, wherein the metal channel is a hat channel type support, the contact area of the metal channel comprises a top area and two side brims, and the vibration/sound suppression material is attached to the top area, and the two side brims.

5. The support structure of claim 3, wherein the metal channel is an RC-1 type metal channel type support, the contact area of the metal channel comprise a top area and one side brim, and the vibration/sound suppression material is attached to the top area and the side brim.

6. The support structure of claim 3, wherein the vibration/sound suppression material comprises a polymer layer, an adhesive layer, and an abrasion resistance layer.

7. The support structure of claim 6, wherein the vibration/sound suppression material comprises strips of material covering contact areas of the metal channel, the contact areas including surfaces contacting any other structures.

8. A metal channel support structure comprising:
a top contact area;
at least one brim contact area; and
vibration/sound suppression material attached to the top contact area and the at least one brim contact area;
wherein the vibration/sound suppression material comprises:
a polymer layer to absorb sound and/or vibrations;
an adhesive layer to attach the polymer layer to the metal channel; and
an abrasion resistance layer covering the polymer layer.

9. The metal channel support structure of claim 8, comprising two brim contact areas, wherein the vibration/sound suppression material is attached to a bottom side of the brim contact areas.

10. The metal channel support structure of claim 8, comprising two brim contact areas, wherein the vibration/sound suppression material is attached to a top side of the brim contact areas.

11. A method of construction comprising:
attaching a vibration/sound suppression material to a channel member;
installing the channel member to support a panel product;
attaching the panel product to the channel member, wherein the vibration/sound suppression material on the channel member contacts the panel product.

12. The method of claim 11, wherein the panel product is a sound engineered drywall product.

13. The method of claim 11, wherein the panel product is a ceiling material.
